(19) United States
(12) Patent Application Publication
(10) Pub. No.: US 2005/0122952 A1
(43) Pub. Date: Jun. 9, 2005

(54) Radio-controlled clock and method for automatically receiving and evaluating any one of plural available time signals

(75) Inventors: Horst Haefner, Heilbronn (DE); Roland Polonio, Neckarsulm (DE); Hans-Joachim Sailer, Heilbronn (DE)

Correspondence Address: FASSE PATENT ATTORNEYS, P.A., P.O. BOX 726, HAMPDEN, ME, 04444-0726, US

(73) Assignees: ATMEL Germany GmbH, Heilbronn (DE); C-MAX EUROPE GMBH, Heilbronn (DE)

(21) Appl. No.: 11/009,180

(22) Filed: Dec. 8, 2004

(30) Foreign Application Priority Data
Dec. 8, 2003 (DE) 103 57 201.5

(51) Int. Cl. H04J 3/06

(52) U.S. Cl. 370/350; 370/509

(57) ABSTRACT

Transmitters respectively transmit time signals providing time information in a succession of time frames having constant duration but different encoding parameters and frequencies. A received time signal is evaluated to determine the particular transmitter that transmitted the signal. For example, the frequency, the duration and number of signal pulses representing second markers, the arrangement and sequence of signal pulses, and/or the inversion state of the signal are evaluated to identify the pertinent transmitter based on these characteristic features. The time information can be properly decoded and evaluated according to the correct protocol, which has been automatically selected. A circuit arrangement for a radio-controlled clock includes a switch unit operating as a selectable frequency filter, and a logic and control unit and/or a program-controlled evaluating unit adapted to evaluate and allocate received time signals to corresponding transmitters, and adapted to retrieve corresponding protocol information from a look-up table or the like.

### PRIORITY CLAIM

This application is based on and claims the priority under 35 U.S.C. §119 of German Patent Application 103 57 201.5, filed on Dec. 8, 2003, the entire disclosure of which is incorporated herein by reference.

### FIELD OF THE INVENTION

The invention relates to a radio-controlled clock, a receiver arrangement for such a clock, as well as a method for acquiring time and/or date information from a time signal transmitted by a time signal transmitter.

### BACKGROUND INFORMATION

It is conventionally known to provide time reference information in time signals that are transmitted by radio transmission from a time signal transmitter. Such a signal may also be called a time marker signal, a time data signal, a time code signal, or a time reference signal, for example, but will simply be called a time signal herein for simplicity. The time signal transmitter obtains the time reference information, for example, from a high precision atomic clock, and broadcasts this highly precise time reference information via the time signal. Thus, any radio-controlled clock receiving the signal can be synchronized or corrected to display the precise time in conformance with the time standard established by the atomic clock that provides the time reference information for the time signal transmitter. The time signal is especially a transmitter signal of short duration, that serves to transmit or broadcast the time reference information provided by the atomic clock or other suitable time reference emitter. In this regard, the time signal is a modulated oscillation generally including plural successive time markers, which each simply represent a pulse when demodulated, whereby these successive time markers represent or reproduce the transmitted time reference with a given uncertainty.

A time signal transmitter as mentioned above is, for example, represented by the official German longwave transmitting station DCF-77, which continuously transmits amplitude-modulated longwave time signals controlled by atomic clocks to provide the official atomic time scale for Central European Time (CET), with a transmitting power of 50 kW at a frequency of 77.5 kHz. In other countries, such as Great Britain, Japan, China, and the United States, for example, similar transmitters transmit time information on carrier waves in a longwave frequency range from 40 kHz to 120 kHz. In all of the above mentioned countries, the time information is transmitted in the time signal by means of a succession of time frames organized in time code telegrams that each have a duration of exactly one minute.

FIG. 1 diagrammatically represents the coding scheme of a time code or time information telegram A that pertains for the encoded time information provided by the German time signal transmitter DCF-77. The coding scheme or telegram in this case consists of 59 bits in 59 time frames, whereby each single bit or time frame corresponds to one second. Thus, the so-called time code telegram A, which especially provides information regarding the correct time and date in binary encoded form, can be transmitted in the course of one minute. The first 15 bits in bit range B comprise a general encoding, which contain operating information, for example. The next 5 bits in bit range C contain general information. Particularly, the general information bits C include an antenna bit R, an announcement bit Al announcing or indicating the transition from Central European Time (CET) to Central European Summer Time (CEST) and back again, zone time bits Z1 and Z2, an announcement bit A2 announcing or indicating a so-called leap second, and a start bit S of the encoded time information.

From the 21^{st} bit to the 59^{th} bit, the time and date informations are transmitted in a Binary Coded Decimal (BCD) code, whereby the respective data are pertinent for the next subsequent or following minute. In this regard, the bits in the range D contain information regarding the minute, the bits in the range E contain information regarding the hour, the bits in the range F contain information regarding the calendar day or date, the bits in the range G contain information regarding the day of the week, the bits in the range H contain information regarding the calendar month, and the bits in the range I contain information regarding the calendar year. These informations are present bit-by-bit in encoded form. Furthermore, so-called test or check bits P1, P2, P3 are additionally provided respectively at the ends of the bit ranges D, E and I. The 60^{th} bit or time frame of the time code telegram A is not occupied, i.e. is “blank” and serves to indicate the beginning of the next telegram A. Namely, the minute marker M following the blank interval represents the beginning of the next time code telegram A.

The structure and the bit occupancy of the encoding scheme or telegram A shown in FIG. 1 for the transmission of time signals is generally known, and is described, for example, in an article by Peter Hetzel entitled “Zeitinformation und Normalfrequenz” (“Time Information and Normal Frequency”), published in Telekom Praxis, Vol. 1, 1993.

In other countries, for example Great Britain, Japan and the United States, the respective time signal transmitters respectively transmit time signals made up of time information telegrams containing respective different encodings, i.e. different coding schemes, of the time information. Namely, the specific example of a coding scheme of a time information telegram A discussed above in connection with FIG. 1 particularly relates to the time signal transmitted by the German transmitter DCF-77. While the time signals pertaining in other countries follow the same general concept of a succession of time information telegrams, the specific encoding within a telegram will differ from country to country.

The transmission of the time marker or code information is performed by amplitude modulating a carrier frequency with the individual second markers. More particularly, the modulation comprises a dip or lowering or reduction X1, X2 (or alternatively an increase or raising) of the carrier signal X at the beginning of each second, except for the 59^{th} second of each minute, when the signal is omitted or blank as mentioned above. In this regard, in the case of the time signal transmitted by the German transmitter DCF-77, the carrier amplitude of the signal is reduced, to about 25% of the normal amplitude, at the beginning of each second for a duration X1 of 0.1 seconds or for a duration X2 of 0.2 seconds, for example as shown in present FIG. 2.

These amplitude reductions or dips X1, X2 of differing duration respectively define second markers or data bits. The differing time durations of the second markers serve for the binary encoding of the time of day and the date, whereby the second markers X1 with a duration of 0.1 seconds correspond to the binary “0” and the second markers X2 with the duration of 0.2 seconds correspond to the binary “1”. Thus the modulation represents a binary pulse duration modulation. As mentioned above, the absence of the 60^{th} second marker announces the next following minute marker.

Thus, in combination with the respective second, it is then possible to evaluate the time information transmitted by the time signal transmitter. FIG. 2 shows a portion of an example of such an amplitude modulated time signal as discussed above, in which the encoding is achieved by respective temporary reductions or dips of the amplitude of the HF signal having different pulse durations. Note that the total duration of each time frame from the beginning of one dip to the beginning of the next dip or second marker X1 or X2 amounts to 1000 ms or 1 second, while the individual dips or amplitude reductions acting as second markers X1 and X2 respectively have individual durations of 100 ms or 200 ms, i.e. 0.1 seconds or 0.2 seconds, as described above for the German transmitter DCF-77.

In other countries, e.g. Great Britain, Japan and the United States, the modulation of the respective time signal is also carried out by dips or reductions, or alternatively peaks or increases, of a carrier signal, but the particular details of the second markers and therewith also the duration of the dips or peaks of the carrier signal vary more or less from country to country. For this reason, a radio-controlled clock or a receiver that receives a time signal must decode and evaluate the time signal correspondingly with regard to the particular encoding scheme with which the time information telegrams have been encoded.

Present day conventional time signal receivers and radio-controlled clocks are typically designed and constructed to receive only a single reception frequency, and to decode and evaluate a time signal according to the encoding scheme that typically pertains for the particular frequency, e.g. for a time signal prevailing in a particular country. If the receiver is to be switchable to operate selectively at any one of plural reception frequencies, then the signal decoding and evaluation carried out by the receiver must also be switched to the corresponding characteristics or properties of the encoding scheme used by the respective time signal transmitter at the selected frequency.

In conventional radio-controlled clocks and receivers, the above considerations make it necessary for the user to manually input or select the desired frequency and/or appropriate reception, decoding and evaluating parameters. While such manual selection may still be manageable if only a total of two available frequencies are provided, it becomes rather difficult, cumbersome, or impossible if a greater number of available reception frequencies and decoding and evaluation parameters are to be provided for a worldwide applicability of the device. Namely, in such a case, it would be necessary to provide for and manually select the correct allocation of the various different frequencies and various different coding parameters with respect to the different transmission protocols used respectively in various different countries. This makes it difficult and not “user friendly” for the user of such radio-controlled clocks or other devices to manually select the correct frequency and encoding parameters for the respective pertinent country or region. Particularly, the user friendliness of such devices is significantly disadvantaged for the above reasons.

Further difficulties arise, because such radio-controlled clocks that are to be suitable for worldwide use, are especially clocks embodied as or incorporated in wristwatches and clocks in portable computers (e.g. laptops, notebooks, PDAs, etc.). Such devices, due to their compact size, require a compact, streamlined, and simple arrangement of the radio-controlled clock incorporated therein as well. Also, such devices are typically high-priced devices, of which the users demand a high functionality and a high user friendliness. Thus, the typically available conventional radio-controlled clocks are not satisfactory for the principle application, namely in such portable devices.

The general technical background of radio-controlled clocks and receiver circuits for receiving time signals as generally discussed above are disclosed in the German Patent Publications DE 198 08 431 A1, DE 43 19 946 A1, DE 43 04 321 C2, DE 42 37 112 A1, and DE 42 33 126 A1. Furthermore, the methods and techniques for acquiring and processing the time information from transmitted time signals are disclosed in Patent Publications DE 195 14 031 C2, DE 37 33 965 C2, and EP 0,042,913 B1. A method for determining the beginning of a second is described in the German Patent Publication DE 195 14 036 C2.

### SUMMARY OF THE INVENTION

In view of the above, it is an object of the present invention to achieve the simplest possible, yet reliable allocation of a received time signal to a particular transmitter that has transmitted that signal with a respective associated specific encoding protocol. It is a further object of the invention to correctly identify a particular time signal transmitter and/or the corresponding time signal encoding parameters pertaining to a particular received time signal, so that the time information may be properly decoded and evaluated. Especially, the invention aims to achieve a substantially automatic identification or allocation of the received signal to the corresponding time signal transmitter and/or its associated encoding protocol parameters. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a method of acquiring time information from at least one transmitted time signal, comprising the steps:
a) receiving a time signal that has been transmitted by a particular transmitter among plural possible time signal transmitters, wherein the time signal comprises a succession of time frames that each respectively have a fixed duration and that encode time information;
b) evaluating the time signal to determine therefrom the particular transmitter that has transmitted the time signal among the plural possible transmitters, and allocating the time signal to the particular transmitter; and
c) evaluating the time signal to acquire the time information therefrom.

The above objects have further been achieved in another embodiment of the invention, in a method of acquiring time information from at least one transmitted time signal, comprising the steps:
a) receiving a time signal that has been transmitted by a particular transmitter among plural possible time signal transmitters, wherein the time signal comprises a succession of time frames that each respectively have a fixed duration and that encode time information according to a particular encoding protocol pertaining to the particular transmitter among plural encoding protocols respectively pertaining to the plural possible time signal transmitters;
b) detecting and evaluating at least one characteristic feature of the time signal to determine therefrom the particular encoding protocol; and
c) evaluating the time signal dependent on the particular encoding protocol to acquire the time information therefrom.

Furthermore, the above objects have been achieved according to the invention in a circuit arrangement, e.g. a radio-controlled clock or a receiver circuit for such a clock, for acquiring time information from plural time signals respectively transmitted by plural different time signal transmitters, the circuit arrangement comprising:
an antenna arrangement adapted to receive the time signals;
an evaluating unit adapted to allocate particular encoding protocols respectively to the time signals based on and dependent on characteristic features of the time signals; and
a decoding unit adapted to decode time informations contained in the time signals based on and dependent on the encoding protocols allocated to the time signals.

Accordingly, the basic idea underlying the invention is to evaluate a received time signal itself, so as to derive therefrom characteristic information identifying a particular time signal transmitter that transmitted the received time signal, and/or the time information encoding parameters pertaining to the received time signal. In this manner, the pertinent transmitter and/or the pertinent encoding parameters can be identified or determined in an automatic or automatable manner. Then, once the pertinent transmitter and/or the pertinent encoding parameters have been identified, the received signal can be suitably decoded and evaluated in accordance with the identified protocol, so as to acquire and determine the time information from the time signal. Throughout this disclosure, the general term “time information” will be regarded as encompassing clock-time (e.g. hour, minute and second) information and/or date (e.g. calendar year, month, date, and day of week) information, unless it is clear from the context of a particular text portion that only clock-time information is being discussed.

In view of the automated or automatable transmitter and encoding parameter recognition according to the invention, the inventive method and circuit arrangement can automatically select, receive and evaluate any one of plural possible different time signals provided on any one of plural possible carrier frequencies, without requiring any (or only minimal) manual input by a user. Instead, the inventive method and circuit arrangement can carry out an automatic transmitter search and selection process. Moreover, when a radio-controlled clock is moved and thus transitions from the range of influence of a first time signal transmitter to that of a second time signal transmitter, the inventive method and circuit arrangement can easily and automatically switch to reception of the new i.e. second time signal at the new i.e. second frequency allocated to the second transmitter, without any manual intervention or input by the user. Thus, the exact accurate time that is valid within the range of influence of the corresponding selected new time signal transmitter will always be properly acquired by the radio-controlled clock or the like.

With the above features, the invention provides a universally applicable radio-controlled clock with worldwide functionality and without requiring any special user input or special procedures upon the initial start-up or resetting of the clock, because the clock at least quasi-automatically sets itself to the respective proper time signal transmitter of which the time signal is to be received. A manual selection or switching of the clock from one time signal to another by the user is not required. This achieves an increased functionality and a greatly improved user-friendliness and user-comfort of the inventive radio-controlled clock, in comparison to conventionally available radio-controlled clocks.

According to the invention, a conclusion as to the transmitter of the presently received time information signal is reached based on characteristic features that are typical respectively for the given time signal transmitter among all available transmitters. These characteristic features are, for example:
a) the frequency of the transmitted time signal;
b) the time duration of a second marker given by a change of a characteristic (e.g. the amplitude) of the time signal;
c) the coding scheme of a telegram of the time signal, namely the particular successive bit combinations that are typical for the respective time signal transmitter; and/or
d) the inversion state of the time signal.

Each of these characteristic features, by itself, can already enable an identification of the time signal and therewith an identification or allocation of the signal to the respective pertinent time signal transmitter. This identification can be unambiguous to the extent that the above mentioned characteristic features or properties are individually and unambiguously associated with individual ones of the available time signal transmitters. For example, the transmitting frequency can already be sufficient to achieve an unambiguous allocation of the time signal to a particular available time signal transmitter. Namely, this is the case if the received time signal has a frequency of 77.5 kHz, which is the frequency used only by the German time signal transmitter DCF-77.

On the other hand, if a frequency of the received time signal cannot be directly and unambiguously allocated to a particular time signal transmitter, then additional or alternative characteristic features of the signal will have to be taken into account. For example, information about the characteristic pulse sequences of the signal can further be taken into account. In this regard, as a particular example, the invention makes use of the fact that the time signal in various countries uses second markers respectively having different durations for the binary encoding of the time information. These time durations are thus typically or very often characteristic for the particular pertinent time signal transmitter. Thus, the corresponding time signal transmitter can already be identified based on its characteristic duration of a second marker in its transmitted time signal. If this information is not sufficient to achieve an unambiguous identification of the pertinent transmitter, then at least one additional time duration (e.g. the time duration of a parameter other than the second marker duration) of the same time signal may further be taken into account.

If two time signal transmitters, such as the US transmitter (WWVB) and the Japanese transmitter (JJY), transmit on the same frequency and respectively have the same duration of a second marker, then the inventive method can nonetheless still correctly and unambiguously identify the respective pertinent transmitter. In this context, the inventive method takes into account the fact that plural successive second markers respectively differ in the signals transmitted by the two above mentioned transmitters (WWVB and JJY). For example, the signal transmitted by the Japanese transmitter JJY is inverted relative to the signal transmitted by the US transmitter WWVB. More particularly, this means that the second markers (e.g. amplitude dips) in the signal of the Japanese transmitter JJY occur at the end of a given time frame, while they are provided at the beginning of a given time frame in the signal of the US transmitter WWVB, as well as in the respective signals of the German transmitter DCF-77 and the British transmitter MSF. These informations are additionally or alternatively used according to the invention, in order to correctly and unambiguously identify the respective pertinent time signal transmitter. It is especially advantageous according to the invention, if the above mentioned various different characteristic features or properties of the signal are taken into account together, i.e. combined with one another, for carrying out the identification or allocation of a time signal to the corresponding pertinent time signal transmitter.

A further advantageous feature of the invention provides a suitable indication in the display of the radio-controlled clock to identify, to the user, the time signal transmitter of which the signal is being presently received. Thereby, the user always knows which transmitter is providing the time information being received and used by the radio-controlled clock. This is especially relevant or useful in boundary or transition areas between (or within the overlap of) areas of influence of at least two time signal transmitters.

The inventive method can be carried out both as a hardware-based method as well as a software-based method, so that it can realize a universal application in a great variety of receiver arrangements in various different radio-controlled clocks. In an advantageous embodiment, the various different encoding schemes or telegram protocols of the various different time signal transmitters can be stored (or various characterizing properties or parameters thereof can be stored) in the form of a table, e.g. a look-up table in a memory provided for this purpose in the radio-controlled clock or its receiver circuit. Additionally or alternatively, the various different encoding schemes or telegram protocols can respectively be implemented in corresponding hardware logic circuits, for example, a programmable logic array (PLD, PLA), a field programmable logic array (FPLA), or a FPGA.

Especially in border or transition areas of the transmission range of a given time signal transmitter, an overlap of two or more transmission areas, e.g. two or more receivable time signals, can arise. Namely, in such areas two or more time signals respectively transmitted by two or more transmitters are available and receivable by the radio-controlled clock. In a particularly advantageous embodiment of the invention, in such cases priorities can be prescribed for determining which time information, i.e. which time signal, among the available plural time signals shall be received, evaluated, and displayed with first priority. As a further alternative, not only the time information of a single highest priority time signal, but rather plural or all available time informations that are received from plural time signal transmitters can be simultaneously received, evaluated, and displayed. For this embodiment, however, the radio-controlled clock must of course be equipped with a suitable expanded display or time indicator, in order to display more than one time. As a still further alternative, the different time informations could be indicated successively in an automatic or manually selectable sequence, rather than being displayed simultaneously.

Additionally or alternatively, the respective intensity of the various received time signals can be measured. From the received signal intensity, a conclusion or inference as to the distance of the receiver from the respective time signal transmitter can be made. For example, the highest received signal intensity is allocated to the closest time signal transmitter. In this regard, the invention provides for receiving, evaluating, and displaying the time information of the time signal having the greatest received intensity.

Advantageously, the beginning of a second marker in the inventive method can be determined, for example, according to the method disclosed in the above mentioned German Patent Publication DE 195 14 036 C2, of which the entire disclosure is incorporated herein by reference.

### BRIEF DESCRIPTION OF THE DRAWINGS

In order that the invention may be clearly understood, it will now be described in connection with example embodiments thereof, with reference to the accompanying drawings, wherein:

FIG. 1 schematically represents the encoding scheme or time code telegram of encoded time information transmitted by the German time signal transmitter DCF-77, as conventionally known;

FIG. 2 is a time diagram representing a portion of an amplitude modulated time signal having five second pulses or markers, shown schematically in idealized form, as transmitted by the German time signal transmitter DCF-77;

FIGS. 3A, 3B, 3C and 3D are schematic time diagrams respectively showing corresponding portions of time signals as transmitted respectively by the time signal transmitters in Germany, Great Britain, the United States, and Japan, for illustrating the differences therebetween;

FIGS. 4A, 4B and 4C are schematic time diagrams respectively showing a portion of an idealized WWVB time signal, a portion of an idealized JJY time signal, and a representation of the differences therebetween; and

FIG. 5 is a schematic circuit diagram of a circuit arrangement suitable for a receiver circuit for a radio-controlled clock according to the invention.

### DETAILED DESCRIPTION OF PREFERRED EXAMPLE EMBODIMENTS AND OF THE BEST MODE OF THE INVENTION

In all of the drawing figures, the same elements and signals, as well as the elements and signals respectively having the same functions, are identified by the same reference numbers, unless the contrary is indicated.

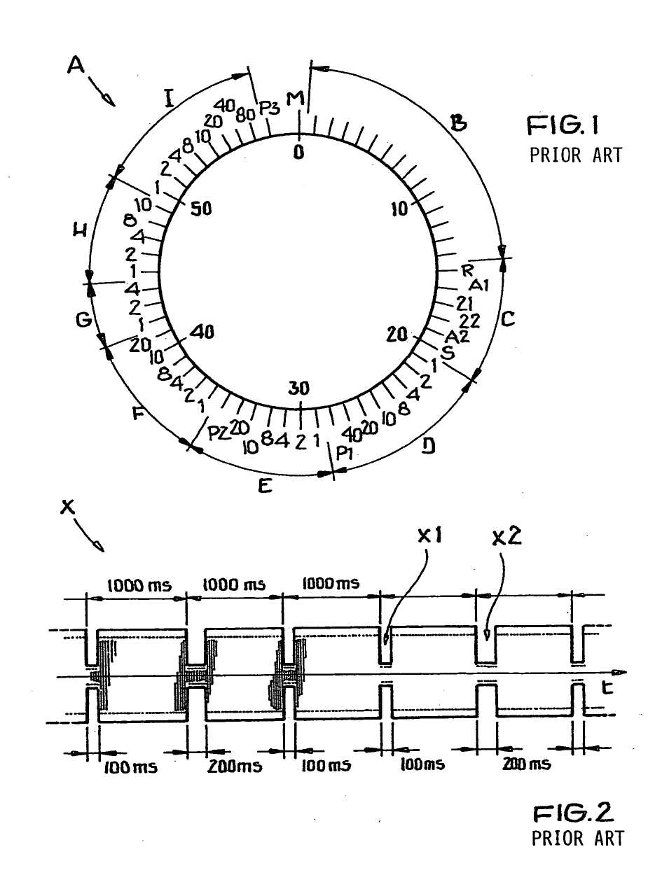

The general format of an encoding scheme or time code telegram A as conventionally known in the time signal transmitted by the German time signal transmitter DCF-77 has been explained above in connection with FIG. 1 in the Background Information section. Similarly, the time-variation of the amplitude-modulated time signal is schematically shown in an idealized manner in the time diagram of FIG. 2 as discussed above.

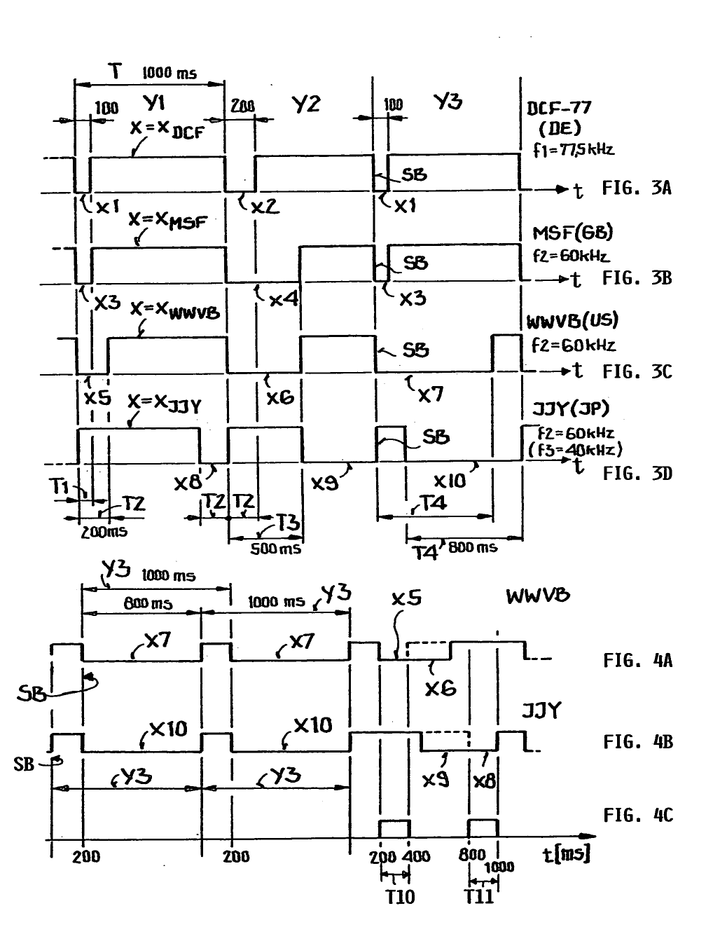

FIGS. 3A, 3B, 3C and 3D are respective time diagrams of portions of time signals as transmitted by the official time signal transmitters in various countries, specifically the transmitter DCF-77 with a carrier frequency f1 of 77.5 kHz in Germany, the transmitter MSF with a carrier frequency f2 of 60 kHz in Great Britain, the transmitter WWVB with a carrier frequency f2 of 60 kHz in the United States, and the transmitter JJY with a carrier frequency f2 of 60 kHz or an alternative carrier frequency F3 of 40 kHz in Japan. The corresponding time signals, generally represented as time signal X, are respectively the time signals X_{DCF}, X_{MSF}, X_{WWVB}, X_{JJY} of the respective national transmitters. While the characterizing features or properties of the various national time signals as shown in FIGS. 3A to 3D are conventionally known, the novel and unobvious inventive method will be discussed in connection with those known features of the several time signals. The illustrations of FIGS. 3A to 3D are merely schematic so as to clearly represent the principle features thereof and the differences therebetween. The illustrations of FIGS. 3A to 3D are not suitable or intended to represent a special particular time information encoding.

The respective portions of these time signals X represented in FIGS. 3A to 3D each include three complete time frames Y1, Y2, and Y3. All of the particular time signals X, i.e. the time signals X_{DCF}, X_{MSF}, X_{WWVB} and X_{JJY}, have the same format of each respective time frame Y. The duration of each time frame Y, e.g. of the exemplary time frames Y1, Y2 and Y3, amounts to T 1000 msec or 1 s. This uniformity is advantageous in order to realize the same or common format of the encoding telegram A as illustrated and discussed above in connection with FIG. 1. Namely, the encoding is such that the respective time code telegram A in the time signal transmitted by each of these transmitters includes sixty second markers in sixty successive time frames Y, whereby, however, the last time frame may be “blank” as discussed above. As will be discussed next, however, the respective time signals X_{DCF}, X_{MSF}, X_{WWVB} and X_{JJY} differ from one another in other aspects, particularly as follows.

a) Transmitting Frequency of the Time Signal.

At least some of the time signals can be distinguished from one another by the transmitting frequency thereof. For example, the time signal X_{DCF} transmitted by the German time signal transmitter DCF-77 is transmitted or emitted at a frequency f1=77.5 kHz. In contrast, the transmitters MSF, WWVB, and JJY all transmit respective time signals at the frequency f2=60 kHz. Thus, the German time signal X_{DCF} can be distinguished from the other national time signals based on the frequency. Moreover, other time signal transmitters, e.g. in other countries, transmit at further transmission frequencies lying in a range from 40 to 120 kHz.

b) Duration and Number of the Second Markers of the Time Signal

Various different time signals transmitted by the different transmitters are respectively characterized by different durations and different numbers of the several second markers making up the time code telegram of the time signal.

The time signal X_{DCF} transmitted by the German transmitter DCF-77 contains a binary encoding of the relevant information with two different second markers X1 and X2 represented by amplitude reductions or dips. The first second marker or dip X1 has the duration T1=100 msec, and the second second marker or dip X2 has the duration T2=200 msec. A binary “0” is allocated to the first dip X1 having the shorter duration, and binary “1” is allocated to the second dip X2 having the longer duration.

In contrast, while the time signals transmitted in the other countries by the transmitters MSF, WWVB and JJY also include dips (or alternatively peaks) of the carrier signal X to encode the pertinent information, they are distinguished from the German time signal X_{DCF} by a different encoding scheme on the one hand, and by different time durations of the respective second markers (e.g. dips or peaks of the signal amplitude) on the other hand.

The time signal X_{MSF} transmitted by the British transmitter MSF comprises a first second marker X3 represented by an amplitude dip having the duration T1=100 msec, and a further second marker X4 represented by an amplitude dip having the duration T3=500 msec.

The respective time signals X_{WWVB} and X_{JJY} transmitted respectively by the US transmitter WWVB and the Japanese transmitter JJY each include three different second markers, namely X5, X6, X7 and X8, X9, X10 represented by amplitude dips. The duration of the first second markers or amplitude dips X5 and X8 is T2=200 msec. The duration of the second second markers or dips X6 and X9 is T3 500 msec. The duration of the third second markers or dips X7 and X10 is T4=800 msec.

c) Beginning of an Amplitude Reduction or Dip of the Time Signal

While the amplitude dips X1 to X7 representing second markers in the time signals X_{DCF}, X_{MSF}, X_{WWVB} respectively are provided immediately at the beginning of a time frame Y1, Y2, Y3, the amplitude dips X8 to X10 of the Japanese time signal X_{JJY} are respectively provided at the end of a respective time frame Y1 to Y3. In the latter case, i.e. in the Japanese time signal X_{JJY}, one refers to this as being an “inverted” time signal. Alternatively, this can be seen as a signal having amplitude peaks rather than amplitude dips beginning at the start of each respective time frame.

In the following, the inventive method for evaluating the time signals X transmitted by the various transmitters for acquiring the pertinent time information will be explained.

1) Evaluation of the Frequency of the Received Time Signal

Upon receiving one or more time signals, the radio-controlled clock or its receiver circuit measures or evaluates the respective frequency of the received time signal or signals. Among the above described exemplary national time signals, the German transmitter DCF-77 is the only time signal transmitter that transmits its signal at the frequency f1=77.5 kHz. Thus, if the receiving radio-controlled clock, by measuring the frequency of the received signal, determines that the received time signal has a frequency of exactly 77.5 kHz, then the inventive method unambiguously reaches the conclusion that the received time signal is the time signal XDF as transmitted by the German time signal transmitter DCF-77. Otherwise, if the measured frequency of the received signal is a common frequency shared among several time signal transmitters, then an unambiguous conclusion and allocation as to the source of the signal cannot be made based on the frequency alone, and a further evaluation will be necessary.

2) Evaluation of the Specific Pulse Durations of the Received Time Signal

As an alternative or in addition to the above mentioned evaluation of the signal frequency, various characteristic features of the received time signal X, and especially the presence of transmitter-specific pulse durations, i.e. the durations of amplitude dips representing second markers X1 to X10, can be evaluated. These pulse durations X1 to X10 are characteristic for various time signal transmitters as discussed above, and are thus present only in the respective time signals transmitted by these identified time signal transmitters. Thus, an evaluation of the characteristic pulse durations, especially further in connection with consideration of the inverted or non-inverted character of the signal encoding, makes it possible to unambiguously identify the time signal transmitter that has transmitted the received time signal.

For acquiring the time information from a received time signal X, the received signal is first evaluated for the presence of characteristic pulse durations by means of a suitable evaluating circuit or software. The characteristic pulse durations X1 to X10 of the received time signals, as represented in FIGS. 3A, 3B, 3C and 3D for example, can amount to t1=100 msec, t2=200 msec, t3=500 sec or t4=800 msec.

If signal pulses having a duration of t1=100 msec, i.e. pulse or second marker durations X1 and X3, are detected, then it is determined that the received time signal is either the signal X_{DCF} from the German transmitter DCF-77 or the signal X_{MSF} from the British transmitter MSF. If this characterizing information by itself is not sufficient for an unambiguous identification and allocation of the source of the signal, then the signal is further evaluated to find another characteristic pulse duration. If pulses X4 having a duration T3=500 msec are additionally detected, then the received signal must be the British time signal X_{MSF}. On the other hand, if the 100 msec pulses are found in combination with further pulses X2 having a duration T2=200 msec, then the received signal must be the German time signal X_{DCF}.

On the other hand, if the received time signal includes no pulses of duration T1=100 msec, but instead includes shortest pulses of a duration T2=200 msec, then the received signal must be the US time signal XX_{WWVB} or the Japanese time signal X_{JJY}. The distinction between these two signals can further unambiguously be evaluated by determining whether the signal is non-inverted with the signal dips at the beginnings of the time frames (which characterizes the US signal), or inverted with the amplitude dips at the ends of the time frames (characterizing the Japanese signal).

As a further example, if pulses X4, X6 or X9 having a duration T3=500 msec are detected, then the received signal cannot be the German signal X_{DCF}, but rather must be one of the signals X_{MSF}, X_{WWVB} or X_{JJY}. Once this is determined, a further evaluation checks whether the received signal includes pulses of a duration T1=100 msec (characterizing the British signal), or whether the signal is a non-inverted signal including pulses of a duration T2=200 msec (characterizing the US signal), or whether the signal is an inverted signal including pulses of a duration T2=200 msec (characterizing the Japanese signal).

3) Evaluation of the Pulse Position Within a Time Frame of the Received Time Signal

As mentioned above, the inverted or non-inverted state of the received time signal, i.e. the pulse position either at the end or at the beginning of a respective time frame, is evaluated to distinguish between the US time signal X_{WWVB} and the Japanese time signal X_{JJY}. Namely, if a non-inverted signal includes pulses X7 having a duration of T4=800 msec, then the signal must be the US signal X_{WWVB}. On the other hand, if an inverted signal, i.e. a signal having inverted pulses X10 with a duration of T4=800 msec is detected, then the signal must be the Japanese signal X_{JJY}, because only the Japanese transmitter JJY transmits inverted 800 msec pulses. For carrying out such an evaluation of the inverted or non-inverted nature of the signal, it is necessary to know or recognize the exact beginning of a second SB in each time frame Y1 to Y3, as indicated in FIGS. 3A, 3B, 3C and 3D.

4) Evaluation of Pulse Sequences of the Received Time Signal

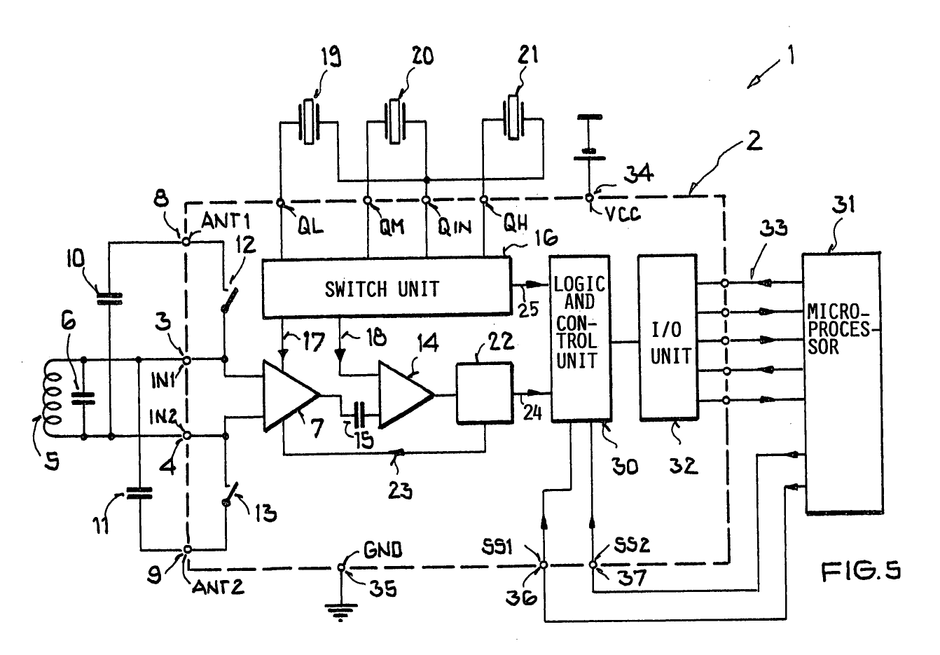

With regard to the above mentioned evaluation of the inverted or non-inverted nature of the signal, the exact time position of each respective time frame Y1 to Y3, and therewith the respective second beginning SB, is very often not known. In that case, the respective time signals X_{WWVB} and X_{JJY} transmitted by the US transmitter WWVB and the Japanese transmitter JJY respectively cannot be unambiguously differentiated based simply on the presence of certain pulse durations, because both of these signals include amplitude dips representing second markers X5 to X7 and X8 to X10 having durations of 200 msec, 500 msec and 800 msec. Thus, the invention provides a special further evaluation of the particular pulse sequences of the respective received signals in order to distinguish between the two signals X_{JJY} and X_{WWVB}, as will be discussed next in connection with FIG. 4.

As described above, the respective time code telegrams in the time signals X_{WWVB} and X_{JJY} respectively include amplitude reductions or dips X7 and X10 having a duration T4=800 msec. In the example illustrated in FIGS. 4A and 4B, the telegrams of the two signals XX_{WWVB} and X_{JJY} respectively have two successive amplitude dips X7 or X10 with a duration of 800 msec at the beginning of a respective minute, i.e. at the beginning of a respective telegram, of the signals. Following the amplitude dips X7 and X10, the telegrams of both signals X_{WWVB} and X_{JJY} include a normal bit represented by an amplitude dip X5 or X6 (in X_{WWVB}) or X8 or X9 (in X_{JJY}) having a duration respectively of T2=200 msec (shown in dashed lines) or having a duration T3=500 msec (shown in solid lines). The difference between the protocols of the transmitter WWVB and the transmitter JJY is that in the signal XX_{WWVB} of the former the amplitude dips X5 to X7 respectively occur at the beginning of the respective associated time frames, while in the signal Xwm of the latter the amplitude dips X8 to X10 respectively occur at the end of the respective associated time frames.

In order to distinguish these two time signals XX_{WWVB} and X_{JJY} from each other, one can initially use the duration of 800 msec as a reference, before it has been clearly determined which protocol the signal complies with. In other words, the beginning of a respective time frame, and thus the second beginning SB is not yet known. In FIGS. 4A and 4B, the two time signals X_{WWVB} and X_{JJY} have been shifted as necessary to achieve a time-alignment of the respective 800 msec pulses X7 and X10 (while the actual time frames are thus offset). As a result, in this representation of FIGS. 4A and 4B, the respective associated time frames Y3 and thus the corresponding second beginnings SB no longer correspond. For this evaluation, however, the particular time-position and correspondence of the beginnings of the time frames relative to each other is not significant. Instead, the inventive method evaluates the sequence of pulses within a given received signal, as follows.

After each of the two 800 msec amplitude dips X7 and X10, the US time signal X_{WWVB} will necessarily exhibit the normal high signal amplitude for 200 msec, making up the remainder of the 1000 msec time frame following the 800 msec amplitude dip X7. This is the case regardless and independent of what encoded pulse duration will follow the 800 msec pulse, i.e. in the next time frame. Then, in the next time frame, depending on the encoding of the next bit of information, the signal X_{WWVB} will include either a 200 msec amplitude dip X5 (shown with dashed lines) or a 500 msec amplitude dip X6 (shown with solid lines).

In contrast to the US time signal, the Japanese time signal X_{JJY} has its amplitude dips respectively at the end of time frames, so that the duration of the normal high amplitude following the second 800 msec dip X10 will have a duration depending on the bit value to be encoded in the next successive time frame. Particularly, as shown in FIG. 4B, following the second amplitude dip X10 in the signal X_{JJY} there will be a period of the normal high amplitude of either 500 msec or 800 msec, depending on whether the next time frame includes a 500 msec amplitude dip X9 (shown in solid lines) or a 200 msec amplitude dip X8 (shown in dashed lines).

Thus, there is clear difference between the two signals in FIGS. 4A and 4B. Namely, in the US signal X_{WWVB}, there will always be the normal maximum signal amplitude for a duration of 200 msec after the 800 msec dip and before the beginning of the next amplitude dip. On the other hand, in the Japanese signal X_{JJY}, there will be the normal maximum signal amplitude for a period of either 500 or 800 msec depending on the bit value to be encoded in the following time frame.

Another way to evaluate the difference between the two signals XX_{WWVB} and X_{JJY} is as follows. The time frame directly following the second 800 msec amplitude dip X7 or X10 is evaluated. As mentioned above, it will be determined that there is a difference between the two signals X_{WWVB} and X_{JJY} regardless whether the following time frame is to include a 200 msec amplitude dip X5 or X8 or a 500 msec amplitude dip X6 or X9. Namely, in the time period T10 from 200 to 400 msec after the end of the second 800 msec pulse (i.e. dip) X7 or X10, the US signal X_{WWVB} will necessarily exhibit a reduction or dip of the signal amplitude, while the Japanese signal X_{JJY} will exhibit the normal maximum signal amplitude. Similarly, in the time period T11 from 800 to 1000 msec after the end of the second 800 msec pulse (i.e. dip) X7 or X10, the Japanese time signal X_{JJY} will exhibit an amplitude reduction or dip, while the US signal X_{WWVB} will not exhibit a reduction, but rather the normal maximum signal amplitude.

On the basis of the above described evaluation of the pulse sequences of the two signals, it can be clearly and unambiguously distinguished whether the received signal is the US time signal X_{WWVB} or the Japanese time signal X_{JJY}. To carry this out, it is simply necessary to recognize and register two successive 800 msec amplitude dips X7 or X10 in the received signal (to ensure that the next dip will not be an 800 msec dip which would not allow the presently described evaluation), and then evaluate the time period T10 from 200 to 400 msec and/or the time period T11 from 800 to 1000 msec following the end of the amplitude dip X7 or X10 to determine whether or not an amplitude reduction of the received signal is present in these time periods. This is an efficient method for distinguishing between the two signals, whereby time as well as the power supply current for carrying out the evaluation can be reduced or saved.

FIG. 5 is a schematic circuit diagram representing a circuit arrangement provided in a receiver circuit for a radio-controlled clock according to the invention. The circuit arrangement 1 comprises an integrated circuit 2 having two inputs 3 and 4 by which the integrated circuit 2 is connected to an antenna arrangement 5, 6, so that an antenna input signal IN1 and IN2 can be coupled into these inputs 3 and 4. In this example embodiment, the antenna arrangement 5, 6 comprises a coil 5 with a ferrite core and a capacitive element 6, for example a capacitance or concretely a capacitor, connected in parallel thereto. The integrated circuit 2 further comprises a regulating or automatic gain control amplifier 7 having its inputs connected to the IC inputs 3 and 4.

The integrated circuit 2 still further comprises two additional inputs 8 and 9, by which the integrated circuit 2 is further connected to the antenna arrangement 5, 6. Namely, the input 8 is connected through a capacitance or capacitor 10 to one of the terminals of the antenna arrangement 5, 6, while the other input 9 is connected through a capacitance or capacitor 11 to the other terminal of the antenna arrangement 5, 6. Thereby, an antenna input signal ANT1 and ANT2 can be coupled in through the inputs 8 and 9. More particularly, the inputs 3 and 4 are cross-connected relative to the inputs 8 and 9, namely the input 9 is connected through the capacitor 11 to the input 3, while the input 8 is connected through the capacitor 10 to the input 4, so that the additional capacitors 10 and 11 may be selectively connected across the antenna 5. Namely, controllable switches 12 and 13 in the integrated circuit 2 respectively selectively connect or disconnect the inputs 8 and 9 to the inputs of the automatic gain control amplifier 7. Thus, by appropriately controlling the switches 12 and 13, the additional capacitances 10 and 11 can be connected or disconnected as needed, whereby the tuning frequency of the antenna arrangement 5, 6 can be suitably adjusted to the transmission frequency of the respective time signal transmitter that transmits the time signal that is to be received.

Instead of using a single antenna 5 in connection with three capacitances 6, 10 and 11 that can be selectively connected or disconnected for suitably adjusting the tuning frequency, the circuit arrangement can alternatively comprise plural separate antennas. In that regard, each of the several antennas is advantageously individually tuned to a respective frequency of the signal that is to be received by that antenna. A disadvantage of such a variant could arise in that the ferrite cores of plural antennas arranged parallel to one another can exert negative influences on each other.

The automatic gain control amplifier 7 has its output connected to an input of the post-amplifier 14, through a compensation or balancing element 15, for example comprising a filter 15 embodied as a capacitor. Thereby, it is possible to compensate or balance-out any parasitic capacitances existing at the inputs of the integrated circuit 2.

The integrated circuit 2 still further comprises a switch unit 16, which may comprise, for example, plural switchable filters. By means of these switchable filters, the switch unit 16 is designed and adapted to provide respective frequency-dependent signals at the output thereof. Furthermore, a control signal line 17 conducts a control signal produced by the switch unit 16 to a control input of the automatic gain control amplifier 7, whereby the amplifier 7 is correspondingly controlled. The switch unit 16 further produces a frequency-dependent output signal that is conducted on the output signal line 18 to a second input of the post-amplifier 14.

Through respective input terminals QL, QM, QIN, and QH, three quartz oscillators or oscillator crystals 19, 20 and 21 respectively having different oscillation frequencies can be connected, as shown, to the circuit arrangement 1. QIN is a common reference, while QL, QM and QH, are, e.g., low, medium and high frequency signal inputs. While the example embodiment shown in FIG. 5 has three quartz oscillators 19 to 21, it is, of course possible to provide a different number of oscillators to achieve a different number or range of frequencies. In the present example embodiment, the first quartz oscillator 19 has an oscillation frequency of 40 kHz, the second quartz oscillator 20 has an oscillation frequency of 60 kHz, and the third quartz oscillator 21 has an oscillation frequency of 77.5 kHz. Thus, the third quartz oscillator 21 is specifically and exactly tuned to the frequency of the German time signal transmitter DCF-77, while the second quartz oscillator 20 is tuned to the specific frequency of the British, US and Japanese time signal transmitters MSF, WWVB and JJY. Furthermore, the first quartz oscillator 19 is tuned to the secondary or alternative transmission frequency F3=40 kHz of the Japanese time signal transmitter JJY. These quartz oscillators 19 to 21, together with the switch unit 16, operate and function as a switchable and tunable filter, especially as a bandpass filter, so as to provide selectivity of the time signal being coupled into the circuit arrangement 1. Preferably and advantageously, the quartz oscillators have a high quality so that they respectively filter out only and precisely the frequency of a specific time signal transmitter, for example 40 kHz, 60 kHz, or 77.5 kHz respectively.

The post-amplifier 14 feeds into and thus activates the following rectifier 22, which produces a regulating or automatic gain control (AGC) signal that is provided through an AGC signal feedback line 23 to the automatic gain control amplifier 7 so as to control the amplifier 7. Furthermore, the rectifier 22 produces at its output, an output signal, for example a square wave TCO signal, that is conducted via an output signal line 24 to a following logic and control unit 30, which can evaluate the time signal in any conventionally known manner to acquire the time information.

The logic and control unit 30 is connected with an input/output or I/O unit 32, which in turn is connected with I/O connections or terminals 33 of the integrated circuit 2. Among other things, the time signal informations that have been decoded, processed, and stored in the logic and control unit 30 can be tapped at these terminals 33. A program-controlled arrangement, e.g. microprocessor or microcontroller 31 connected externally to the integrated circuit 2 via the input/output terminals 33 can thus read-out the time signal informations that have been decoded, processed and stored in the logic and control unit 30 as needed. This program-controlled arrangement 31 may, for example, be a four-bit microcontroller or a microprocessor. Furthermore, a clock signal can be provided to the integrated circuit 2 and particularly the logic and control unit 30 via a suitable terminal connection 33. As an alternative, the logic and control unit may only partially decode, process and store the time signals, which can then be read out and finally evaluated to acquire the time information by the program-controlled arrangement 31.

For the further control of the logic and control unit 30, this unit 30 is connected via control signal line 25 to the switch unit 16, which provides a frequency-dependent control signal through the line 25 to the unit 30.

The integrated circuit 2 further comprises connections, contacts or terminals 36 and 37, by which control signals SS1 and SS2 from the program-controlled arrangement 31 are provided to the logic and control unit 30.

The inventive evaluation of a respective received time signal, and thus also the identification or allocation of the time signal to the time signal transmitter that has transmitted this received signal, is carried out in the logic and control unit 30 or alternatively in the external program-controlled arrangement 31. More particularly, thereby the information of the time signal is evaluated as described above in connection with FIGS. 3A to 3D and 4A to 4C. Moreover, the received time signal is evaluated to obtain the time information encoded therein, according to any conventionally known or future developed processes. In that regard, the inventive method can be carried out in a hardware-based manner, for example being implemented through suitable circuit connections of electronic components and logic gates, for example in the form of PLDs or FPGAs. Additionally or alternatively, the inventive evaluation method can be carried out in a software-based implementation, namely in a program-controlled arrangement such as the arrangement 31 or any other microprocessor or microcontroller provided for that purpose.

For the power supply, the integrated circuit 2 further has a first power supply terminal 34, for example connected to a first supply potential VCC, such as a positive supply potential or battery potential, and a second power supply terminal 35, for example connected to a second supply potential GND such as a negative supply potential or the reference potential of the reference mass or ground. The specific circuit connections of the individual components of the integrated circuit 2 with the power supply terminals 34 and 35 is omitted from the schematic illustration of FIG. 5 for simplicity and improved clarity, but such connections are readily understood by the person of ordinary skill in this field.

Although the invention has been described and illustrated above in connection with preferred example embodiments thereof, the invention is not limited to these disclosed embodiments, but rather is modifiable to cover a great variety and number of different embodiments. For example, the invention is not limited to the particular numerical values or ranges disclosed herein as examples. To the contrary, the scope of the invention also covers variations or changes of numerical values and ranges as would be understood by a person of ordinary skill in the art upon considering the present disclosure.

In the above described example embodiments, the time encoding was realized by temporary dips or reductions of the signal amplitude of the carrier signal in respective time frames. It should be understood that the encoding could alternatively be realized by temporary increases or any other variation of the signal amplitude of the carrier signal in the respective time frames. Also, other types of signal modulation could alternatively be used.

While the above discussion has especially related to a radio-controlled clock receiving the time signal via a wireless radio transmission through an antenna, the present invention also relates to a method and clock apparatus receiving a time signal via a hard-wired transmission. For example, systems including several clocks that are to be synchronized with one another and that are connected to each other by a time signal wire for this purpose, can also be embodied according to the present invention, and are covered within the scope of the appended claims. Such clocks may generally be regarded as remote-controlled clocks, but are also to be understood within the term radio-controlled clocks.

The illustrated and explained example embodiment of a receiver circuit is merely one possible example of a concrete circuit for embodying an inventive receiver circuit and radio-controlled clock. This example embodiment can readily be varied by exchanging individual or simple circuit components or entire functional blocks or units, as would be understood by a person of ordinary skill in the art upon considering this disclosure.

The invention is also not limited to the particular time signal transmitters and their respective associated time signal protocols as described herein. To the contrary, the inventive method and circuit arrangement also apply in an analogous manner to any other time signals transmitted by any other time signal transmitters, for example the conventionally known Chinese time signal transmitter BPC.

Although the invention has been descried with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of acquiring time information from at least one transmitted time signal, comprising the steps:
a) receiving a time signal that has been transmitted by a particular transmitter among plural possible time signal transmitters, wherein said time signal comprises a succession of time, frames that each respectively have a fixed duration and that encode time information;
b) evaluating said time signal to determine therefrom said particular transmitter that has transmitted said time signal among said plural possible transmitters, and allocating said time signal to said particular transmitter; and
c) evaluating said time signal to acquire said time information therefrom.

2. The method according to claim 1, wherein said evaluating in said step c) is carried out according to and dependent on said allocating in said step b).

3. A method of acquiring time information from at least one transmitted time signal, comprising the steps:
a) receiving a time signal that has been transmitted by a particular transmitter among plural possible time signal transmitters, wherein said time signal comprises a succession of time frames that each respectively have a fixed duration and that encode time information according to a particular encoding protocol pertaining to said particular transmitter among plural encoding protocols respectively pertaining to said plural possible time signal transmitters;
b) detecting and evaluating at least one characteristic feature of said time signal to determine therefrom said particular encoding protocol; and
c) evaluating said time signal dependent on said particular encoding protocol to acquire said time information therefrom.

4. The method according to claim 3, wherein said evaluating in said step c) comprises decoding said time information in accordance with said particular encoding protocol.

5. The method according to claim 3, further comprising identifying said particular transmitter in response to and dependent on said particular encoding protocol that has been determined in said step b) and that pertains to said particular transmitter.

6. The method according to claim 5, further comprising allocating said time signal to said particular transmitter.

7. The method according to claim 5, further comprising outputting or emitting information that informs of said particular transmitter that has been identified.

8. The method according to claim 3, wherein said characteristic feature detected and evaluated in said step b) is a characteristic transmission frequency of said time signal.

9. The method according to claim 8, wherein, if said characteristic transmission frequency is 77.5 kHz, then said step b) determines therefrom that said particular encoding protocol is an encoding protocol pertaining to the German time signal transmitter DCF-77 as said particular transmitter.

10. The method according to claim 8, wherein, if said characteristic transmission frequency is 40 kHz, then said step b) determines therefrom that said particular encoding protocol is an encoding protocol pertaining to the Japanese time signal transmitter JJY as said particular transmitter.

11. The method according to claim 3, wherein said time information is encoded in said time frames of said time signal by variations of a parameter of said time signal, and said at least one characteristic feature detected and evaluated in said step b) comprises a characteristic first time duration of at least one of said variations of said time signal.

12. The method according to claim 11, wherein said variations respectively have durations of at least one of 100 msec, 200 msec, 500 msec, and 800 msec.

13. The method according to claim 11, wherein said at least one characteristic feature detected and evaluated in said step b) further comprises a characteristic second time duration of at least another one of said variations of said time signal.

14. The method according to claim 13, wherein, if said first time duration is 100 msec and said second time duration is 200 msec, then said step b) determines-therefrom that said particular encoding protocol is an encoding protocol pertaining to the German time signal transmitter DCF-77 as said particular transmitter.

15. The method according to claim 13, wherein, if said first time duration is 100 msec and said second time duration is 500 msec, then said step b) determines therefrom that said particular encoding protocol is an encoding protocol pertaining to the British time signal transmitter MSF as said particular transmitter.

16. The method according to claim 13, wherein said at least one characteristic feature detected and evaluated in said step b) further comprises a characteristic third time duration of at least a further one of said variations of said time signal.

17. The method according to claim 13, wherein said at least one characteristic feature detected and evaluated in said step b) further comprises a relative timing position of said variations of said parameter within said time frames, and wherein, if said first time duration is any one of 200 msec, 500 msec and 800 msec and said second time duration is any other one of 200 msec, 500 msec and 800 msec, and said relative timing position is that said variations are present at respective beginnings of said time frames, then said step b) determines therefrom that said particular encoding protocol is an encoding protocol pertaining to the United States time signal transmitter WWVB.

18. The method according to claim 13, wherein said at least one characteristic feature detected and evaluated in said step b) further comprises a relative timing position of said variations of said parameter within said time frames, and wherein, if, said first time duration is any one of 200 msec, 500 msec and 800 msec and said second time duration is any other one of 200 msec, 500 msec and 800 msec, and said relative timing position is that said variations are present at respective endings of said time frames, then said step b) determines therefrom that said particular encoding protocol is an encoding protocol pertaining to the Japanese time signal transmitter JJY.

19. The method according to claim 11, wherein said at least one characteristic feature detected and evaluated in said step b) further comprises a characteristic sequence and/or pattern of said variations of said parameter of said time signal.

20. The method according to claim 19, wherein said detecting and evaluating of said characteristic sequence and/or pattern comprises detecting a plurality of successive ones of said time frames respectively having first ones of said variations that each have said characteristic first time duration, measuring an elapsed time that has elapsed following an end of a last one of said first variations, and detecting whether a further one of said variations is present at at least one prescribed time point or within at least one prescribed time interval following said end of said last one of said first variations.

21. The method according to claim 20, wherein said plurality is two of said time frames respectively having two of said first variations in succession, said first time duration of said first variations is 800 msec, and said at least one prescribed time interval comprises at least one of a first time interval at 200 to 400 msec and a second time interval at 800 to 1000 msec following said end of said last one of said first variations.

22. The method according to claim 21, wherein, if said further one of said variations is present in said first time interval and/or if said further one of said variations is not present in said second time interval, then said step b) determines therefrom that said particular encoding protocol is an encoding protocol pertaining to the United States time signal transmitter WWVB as said particular transmitter.

23. The method according to claim 21, wherein, if said further one of said variations is not present in said first time interval and/or if said further one of said variations is present in said second time interval, then said step b) determines therefrom that said particular encoding protocol is an encoding protocol pertaining to the Japanese time signal transmitter JJY as said particular transmitter.

24. The method according to claim 11, wherein said parameter of said time signal is an amplitude of said time signal.

25. The method according to claim 24, wherein said variations are temporary reductions of said amplitude of said time signal.

26. The method according to claim 24, wherein said time information is encoded bit-wise in said time frames with at least one data bit respectively encoded in each one of said time frames, a logic.value of each respective one of said data bits is determined by a respective duration of a respective one of said variations of said amplitude corresponding to said respective data bit, a first said logic value is allocated to a first said duration, and a second said logic value is allocated to a second said duration.

27. The method according to claim 26, wherein said first logic value is a logic zero and said second logic value is a logic one.

28. The method according to claim 3, wherein said time information is encoded in said time frames of said time signal by variations of a parameter of said time signal, and said at least one characteristic feature that is detected and evaluated in said step b) comprises a timing position of a beginning of a respective one of said variations relative to a beginning of a respective one of said time frames in which said respective variation exists.

29. The method according to claim 28, wherein said timing position defines an inverted or non-inverted form of said variations in said time signal.

30. The method according to claim 28, wherein, if said timing position is such that said beginning of said respective variation is time-delayed after said beginning of said respective time frame, then said step b) determines therefrom that said particular encoding protocol is an encoding protocol pertaining to the Japanese time signal transmitter JJY.

31. The method according to claim 3, wherein said time signal is a first time signal, and further comprising receiving a second time signal that has been transmitted by a second transmitter among said plural possible time signal transmitters wherein said second time signal comprises a succession of said second time frames that each respectively have a fixed duration and that encode second time information according to a second encoding protocol, prescribing priorities that define which one of said time signals shall be given a higher priority, and carrying out said steps b) and c) for said first time signal and not for said second time signal in accordance with said priorities.

32. The method according to claim 31, wherein said priorities are based on respective received signal intensities of said time signals, and further comprising measuring a first received signal intensity of said first time signal and a second received signal intensity of said second time signal, and assigning said priorities to said first and second time signals respectively based on said first and second received signal intensities.

33. The method according to claim 32, wherein said time signal having a highest level of said received signal intensity is the time signal that will be subjected to said steps b) and c).

34. The method according to claim 3, wherein said time signal is a first time signal, and further comprising receiving a second time signal that has been transmitted by a second transmitter among said plural possible time signal transmitters wherein said second time signal comprises a succession of second time frames that each respectively have a fixed duration and that encode second time information according to a second encoding protocol, and further carrying out said steps b) and c) not only for said first time signal but also for said second time signal respectively.

35. A circuit arrangement for acquiring time information from plural time signals respectively transmitted by plural different time signal transmitters, said circuit arrangement comprising:
an antenna arrangement adapted to receive said time signals;
an evaluating unit adapted to allocate particular encoding protocols respectively to said time signals based on and dependent on characteristic features of said time signals; and
a decoding unit adapted to decode time informations contained in said time signals. based on and dependent on said encoding protocols allocated to said time signals.

36. The circuit arrangement according to claim 35, wherein said antenna arrangement comprises a ferrite antenna, plural capacitors, and switches arranged and adapted to selectively connect one or more of said capacitors to said ferrite antenna so as to adjust a tuning frequency of said antenna arrangement to a transmission frequency of a respective one of said time signal transmitters.

37. The circuit arrangement according to claim 35, further comprising a memory storing a look-up table that contains respective parameters of said encoding protocols that are respectively associated with said time signal transmitters.

38. The circuit arrangement according to claim 35, wherein said circuit arrangement comprises, embodies, or forms a part of a straight-through receiver.

39. The method according to claim 35, further comprising a display adapted to display a time based on said time information and to indicate which one of said time signal transmitters is the source of said time information.
